(19) United States
(12) Patent Application Publication
(10) Pub. No.: US 2022/0344757 A1
(43) Pub. Date: Oct. 27, 2022

(54) VEHICLE BATTERY CASE

(71) Applicants: Hyundai Motor Company, Seoul (KR); Kia Corporation, Seoul (KR); HYUNDAI STEEL COMPANY, Incheon (KR); SEOJIN INDUSTRIAL Co., Ltd., Grunpo (KR)

(72) Inventors: Sung Ho YOON, Seoul (KR); Uk HEO, Incheon (KR); Jin Yee NOH, Incheon (KR); Dong Yul LEE, Incheon (KR); Han Young HWANG, Ansan (KR); Sang Pil PARK, Gunpo (KR)

(21) Appl. No.: 17/532,086

(22) Filed: Nov. 22, 2021

(30) Foreign Application Priority Data
Apr. 22, 2021 (KR) 10-2021-0052501

(51) Int. Cl. H01M 50/242; B60K 1/04; H01M 50/249

(52) U.S. Cl. CPC H01M 50/242; B60K 1/04; H01M 50/249; H01M 2220/20

(57) ABSTRACT

A vehicle battery case includes: a housing in which a battery is mounted and which has a side surface part formed to cover the side surface of the battery; a side upper panel coupled to the side surface part of the housing and extending in a longitudinal direction along the side surface part; a side lower panel coupled to the side surface part of the housing while being spaced downward apart from the side upper panel and extending in the longitudinal direction along the side surface part of the housing, an end of the side lower panel being coupled to an end of the side upper panel so as to form an impact absorption space between the side lower panel and the side upper panel; and a reinforcement panel inserted into the impact absorption space and extending in the longitudinal direction along the side surface part of the housing.

### CROSS REFERENCE TO RELATED APPLICATION

The present application claims under 35 U.S.C. § 119(a) the benefit of Korean Patent Application No. 10-2021-0052501, filed Apr. 22, 2021, the entire contents of which are incorporated by reference herein.

### BACKGROUND

### 1. Technical Field

The present disclosure relates to a vehicle battery case in which an impact absorption space is formed by a side upper panel and a side lower panel on a side surface part of a housing on which a battery is mounted, and a reinforcement panel having a predetermined inclination secures stiffness against lateral collisions in the impact absorption space.

### 2. Description of the Related Art

A vehicle battery case refers to a device for accommodating a battery module in a vehicle, the vehicle battery case arranged for protecting the battery against external environments and impacts. For example, the vehicle may be an electric vehicle having a traveling distance of 400 km or more have a battery capacity of 60 kWh or more, and a protective device for protecting the battery module typically is made of aluminum for the purpose of lightness.

An electric vehicle having a traveling distance of less than 400 km typically has a protective device made of a steel material, but this has a problem in that a simple structure (having the shape of a slab and an angled tube) for mounting on a side lower portion of the chassis is applied, and cannot sufficiently protect the battery module against collision or compressive load.

That is, a battery case made of steel has a simple structure which buckles in the case of a lateral collision and an external force applied thereto, and is not advantageous for lightness. Therefore, there is a need for development of a vehicle battery case capable of securing stiffness against lateral collisions while using a steel material.

The above descriptions regarding background technologies have been made only to help understanding of the background of the present disclosure, and are not to be deemed by those skilled in the art to correspond to already-known prior arts.

### SUMMARY

The present disclosure provides a vehicle battery case in which an impact absorption space is formed by a side upper panel and a side lower panel on a side surface part of a housing on which a battery is mounted, and a reinforcement panel having a predetermined inclination secures stiffness against lateral collisions in the impact absorption space, thereby preventing buckling deformation.

According to an aspect of the present disclosure, a vehicle battery case may include: a housing in which a battery is mounted and which has a side surface part formed to cover a side surface of the battery; a side upper panel which is coupled to the side surface part of the housing and extends in a longitudinal direction along the side surface part of the housing; a side lower panel which is coupled to the side surface part of the housing while being spaced downward apart from the side upper panel and extends in the longitudinal direction along the side surface part of the housing, an end of the side lower panel being coupled to an end of the side upper panel so as to form an impact absorption space between the side lower panel and the side upper panel; and a reinforcement panel which is inserted into the impact absorption space and extends in the longitudinal direction along the side surface part of the housing, wherein the side lower panel and the reinforcement panel are disposed to have increasing inclinations while extending from the side surface part of the housing in a width direction.

The reinforcement panel may be disposed closer to the side lower panel than to the side upper panel, and when an impact occurs, the reinforcement panel may be deformed and brought into contact with the side lower panel.

The side surface part of the housing may include multiple side wall panels stacked in the lateral direction, and each of the side upper panel, the side lower panel, and the reinforcement panel may have an end coupled to an outermost side wall panel.

The multiple side wall panels may be shaped to extend along a side surface of the housing and coupled to each other to form a closed section.

The upper panel may have multiple protrusions arranged in a longitudinal direction, and each of the protrusions may have an end supported by the reinforcement panel.

The protrusions may include pipe members formed in a cylindrical shape, the side upper panel may have multiple through-holes which are formed in the longitudinal direction and into which the pipe members are inserted, respectively, and the inserted pipe members may have bottoms supported by a top surface of the reinforcement panel.

The reinforcement panel may be shaped to be continuously bent in a longitudinal direction, and may include ridges protruding upward and troughs protruding downward.

The ridges and troughs of the reinforcement panel may have increasing inclinations while extending from the side surface part of the housing in a width direction, and the ridges and the troughs may have different inclinations.

The side upper panel may have multiple through-holes formed in a longitudinal direction, the pipe members may be inserted into the respective through-holes, and the inserted pipe members may have bottoms supported by the ridges of the reinforcement panel.

Each of the ridges of the reinforcement panel may include: an inner portion extending from the side surface part of the housing in a width direction; and an outer portion extending from the inner portion in the width direction, and each of the pipe members may have a bottom supported by the outer portion.

In each ridge of the reinforcement panel, the inner portion may be formed to have a larger inclination value than the outer portion.

In each ridge of the reinforcement panel, the inner portion may be formed to have a smaller inclination value than the side lower panel.

The troughs of the reinforcement panel may be formed to have a larger inclination value than the side lower panel.

The side upper panel may have an end bent upward, the side lower panel and the reinforcement panel may have ends bent downward, and the bent ends may be coupled to each other while being in surface contact with each other or with the side surface part of the housing.

The side upper panel may have an end bent downward, the side lower panel and the reinforcement panel may have ends bent upward, and the bent ends may be coupled to each other while being in surface contact with each other.

A vehicle battery case according to the present disclosure is advantageous in that an impact absorption space is formed by a side upper panel and a side lower panel on a side surface part of a housing on which a battery is mounted, and a reinforcement panel having a predetermined inclination secures stiffness against lateral collisions in the impact absorption space, thereby preventing buckling deformation.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is an exploded perspective view of a side surface of a housing in a vehicle battery case according to an embodiment of the present disclosure;

FIG. 2 illustrates a side upper panel, a side lower panel, and a reinforcement panel in a vehicle battery case according to an embodiment of the present disclosure;

FIG. 3 is a cross-sectional view illustrating a state in which a side upper panel, a side lower panel, and a reinforcement panel are coupled to each other in a vehicle battery case according to an embodiment of the present disclosure;

FIG. 4 illustrates that a side upper panel, a side lower panel, and a reinforcement panel are deformed by a lateral load in the state of being coupled to each other in a vehicle battery case according to an embodiment of the present disclosure;

FIG. 5 illustrates deformation of a conventional vehicle battery case, caused by a lateral load; and

FIG. 6 is a graph showing the amount of deformation of a vehicle battery case according to an embodiment of the present disclosure and a conventional vehicle battery case, depending on a lateral load.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-of”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

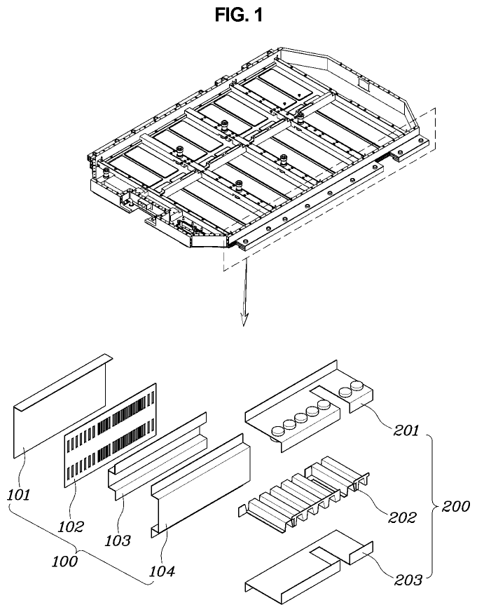

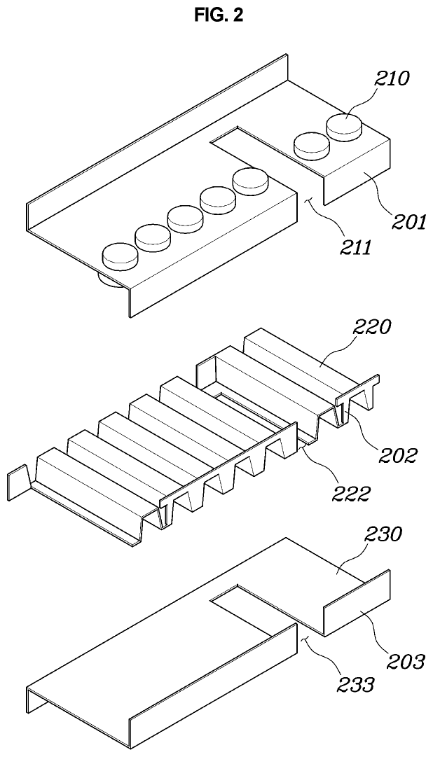

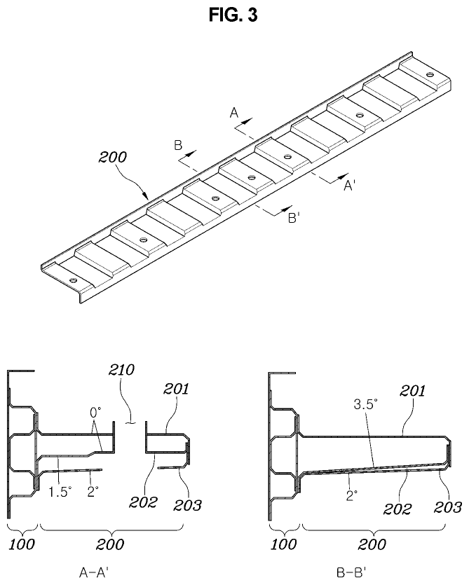

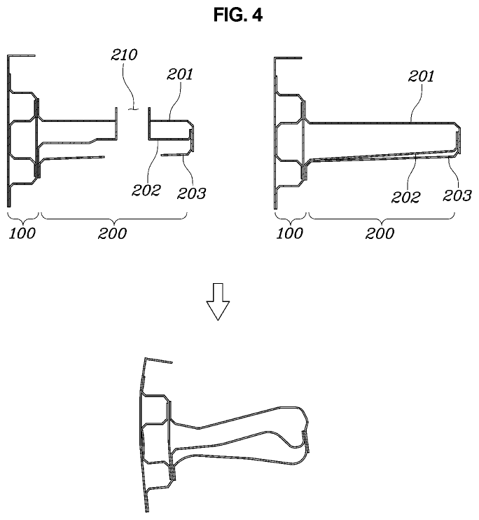

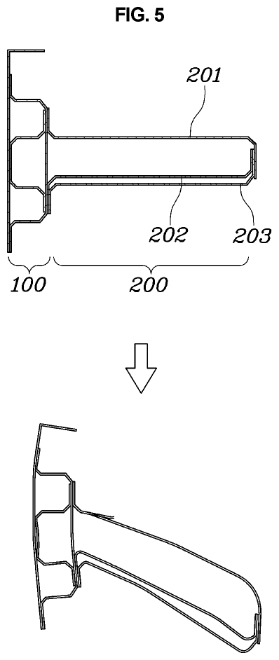

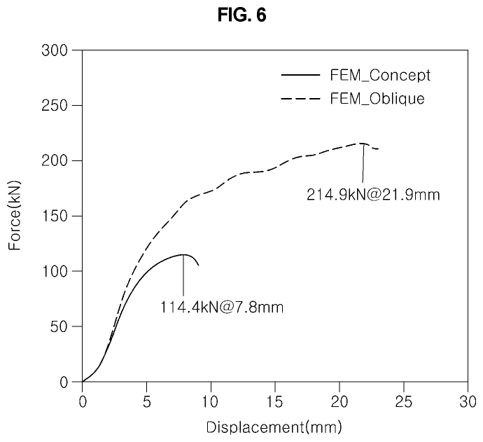

FIG. 1 is an exploded perspective view of a side surface of a housing in a vehicle battery case according to an embodiment of the present disclosure. FIG. 2 illustrates a side upper panel, a side lower panel, and a reinforcement panel in a vehicle battery case according to an embodiment of the present disclosure. FIG. 3 is a cross-sectional view illustrating a state in which a side upper panel, a side lower panel, and a reinforcement panel are coupled to each other in a vehicle battery case according to an embodiment of the present disclosure. FIG. 4 illustrates that a side upper panel, a side lower panel, and a reinforcement panel are deformed by a lateral load in the state of being coupled to each other in a vehicle battery case according to an embodiment of the present disclosure. FIG. 5 illustrates deformation of a conventional vehicle battery case, caused by a lateral load. FIG. 6 is a graph showing the amount of deformation of a vehicle battery case according to an embodiment of the present disclosure and a conventional vehicle battery case, depending on a lateral load.

FIG. 1 is an exploded perspective view of a side surface of a housing in a vehicle battery case according to an embodiment of the present disclosure. The vehicle battery case according to an embodiment of the present disclosure may include: a housing in which a battery is mounted and which has a side surface part 100 formed to cover the side surface of the battery; a side upper panel 201 which is coupled to the side surface part 100 of the housing and extends in the longitudinal direction along the side surface part 100 of the housing; a side lower panel 203 which is coupled to the side surface part 100 of the housing while being spaced downward apart from the side upper panel 201 and extends in the longitudinal direction along the side surface part 100 of the housing, the end of the side lower panel 203 being coupled to the end of the side upper panel 201 so as to form an impact absorption space between the side lower panel 203 and the side upper panel 201; and a reinforcement panel 202 which is inserted into the impact absorption space and extends in the longitudinal direction along the side surface part 100 of the housing, wherein the side lower panel 203 and the reinforcement panel 202 are disposed to have increasing inclinations while extending from the side surface part of the housing in the width direction. Further, the reinforcement panel 202 may be disposed closer to the side lower panel 203 than to the side upper panel 201, and when an impact occurs, the reinforcement panel 202 may be deformed and brought into contact with the side lower panel 203.

Research and development efforts recently have focused on an electric vehicle, and because a battery is an essential element of the electric vehicle, much time and attention have focused on developing a case for mounting the battery. A battery case is configured such that a high-voltage battery for driving the electric vehicle can be mounted or replaced, and at the time of a vehicle collision, is required to absorb and distribute a load and thus prevent a fire and explosion due to battery damage. If the side wall of the battery case is formed of simple steel beams, buckling deformation may be easily caused by an impact as a side member become extended in a transverse direction. Therefore, if the buckling deformation is not prevented, a battery may be damaged by the impact.

The buckling deformation may be prevented by increasing the second moment of area. In this case, the weight of the battery case may increase with an increase in the cross-section thickness of a steel material, and thus power efficiency may be reduced. Therefore, the battery case according to an embodiment of the present disclosure ensures stiffness and a minimized weight by forming a closed section using side wall panels made of a steel material and through inclinations of panels laterally disposed at the outer side of the battery case.

Specifically, in the vehicle battery case according to an embodiment of the present disclosure, the side surface part 100 of the housing may include multiple side wall panels 101, 102, 103, and 104 which are stacked in the lateral direction, and each of the side upper panel 201, the side lower panel 203, and the reinforcement panel 202 may be coupled at the end thereof to an outermost side wall panel 104. The multiple side wall panels 101, 102, 103, and 104 may be shaped to extend along the side surface of the housing, and may be coupled to each other to form a closed section.

That is, the multiple side wall panels 101, 102, 103, and 104 may form a side wall of the battery case, and may effectively withstand a load applied from the side surface through a closed section structure, thereby protecting a battery. Further, the side upper panel 201, the side lower panel 203, and the reinforcement panel 202 may form an impact absorption space, and may prevent buckling deformation of the side surface structure of the battery case, thereby performing functions of absorbing and distributing a load applied from the side surface.

FIG. 2 illustrates a side upper panel, a side lower panel, and a reinforcement panel in a vehicle battery case according to an embodiment of the present disclosure. FIG. 3 is a cross-sectional view illustrating a state in which a side upper panel, a side lower panel, and a reinforcement panel are coupled to each other in a vehicle battery case according to an embodiment of the present disclosure. In the vehicle battery case according to an embodiment of the present disclosure, the side upper panel 201 has multiple protrusions 210 arranged in the longitudinal direction, and each of the protrusions 210 may be supported at the end thereof by the reinforcement panel 202. Further, the protrusions 210 include pipe members 210 formed in a cylindrical shape, the side upper panel 201 has multiple through-holes which are formed in the longitudinal direction and into which the pipe members 210 are inserted, respectively, and the inserted pipe members 210 may be supported at the bottoms thereof by the top surface of the reinforcement panel 202.

Specifically, the panels may be coupled to each other through welding. The panels are thin, and thus may be coupled to each other by mainly using spot welding and partially using laser welding. The pipe members 210 may be inserted into the through-holes of the side upper panel 201, and may be coupled thereto through arc welding. Further, the side upper panel 201, the reinforcement panel 202, and the side lower panel 203 may be coupled to each other by spot welding while being in surface contact with each other through flanges arranged at the ends thereof. The multiple side wall panels 101, 102, 103, and 104 may also be spot-welded and coupled to each other through flanges formed at the tops or bottoms thereof.

Referring to FIG. 3, the side lower panel 203 has an angle of about 2 degrees as an inclination increasing toward the outer side thereof. The reinforcement panel 202 may have a stepped portion formed at the top surface thereof, and thus may have an angle close to 0 degrees as an inclination at a top point of the stepped portion, at which the pipe member is supported, and inside the corresponding point, may have an angle of about 1.5 degrees as an inclination increasing toward the outer side thereof, and may have an angle of about 3.5 degrees as an inclination increasing from the lower end of the stepped portion toward the outer side thereof. Therefore, compared with the case in which the panels are simply stacked and coupled to each other in the upward/downward direction without any inclination, the battery case according to an embodiment of the present disclosure may be uniformly deformed at the time of lateral collision, thereby maximizing prevention of buckling deformation and absorbing and distributing impact.

FIG. 4 illustrates that a side upper panel, a side lower panel, and a reinforcement panel are deformed by a lateral load in the state of being coupled to each other in a vehicle battery case according to an embodiment of the present disclosure. FIG. 5 illustrates deformation of a conventional vehicle battery case, caused by a lateral load. FIG. 6 is a graph showing the amount of deformation of a vehicle battery case according to an embodiment of the present disclosure and a conventional vehicle battery case, depending on a lateral load. Referring to FIG. 5, if multiple panels are simply coupled to each other without any inclination, at the time of lateral collision, the panels are deformed downward by a load, and thus cannot absorb and withstand the load. Therefore, the load may be applied to the battery as it is. As illustrated in FIG. 4, the vehicle battery case according to an embodiment of the present disclosure may maintain the original shape thereof as intact as possible without being buckled upward or downward thanks to the inclination of each panel even when a lateral load is applied, and may be uniformly deformed, thereby absorbing and withstanding the impact.

Specifically, in the vehicle battery case according to an embodiment of the present disclosure, the reinforcement panel 202 is shaped to be continuously bent in the longitudinal direction, and may include: ridges protruding upward; and troughs protruding downward. Further, the ridges and troughs of the reinforcement panel 202 have increasing inclinations while extending from the side surface part of the housing in the width direction, and the ridges and the troughs may have different inclinations.

Further, in the vehicle battery case according to an embodiment of the present disclosure, the side upper panel 201 may have multiple through-holes formed in the longitudinal direction, the pipe members 210 may be inserted into the respective through-holes, and the inserted pipe members 210 may be supported at the bottoms thereof by the ridges of the reinforcement panel 202.

In the vehicle battery case according to an embodiment of the present disclosure, each of the ridges of the reinforcement panel 202 may include: an inner portion extending from the side surface part 100 of the housing in the width direction; and an outer portion extending from the inner portion in the width direction, and each of the pipe members 210 may be supported at the bottom thereof by the outer portion. In each ridge of the reinforcement panel 202, the inner portion may be formed to have a larger inclination value than the outer portion. Referring to FIG. 3, it is determined that a portion corresponding to a point at which the bottom of the pipe member 210 is supported is formed to have an angle of about 0 degrees, and a portion inside the corresponding point is formed to have an angle of about 1.5 degrees. Therefore, at the time of lateral collision, the portion having an angle of about 0 degrees may be deformed downward, and the portion having an angle of about 1.5 degrees may be deformed upward, whereby the overall side structure may totally absorb a load while remaining as horizontal as possible without tilting up or down.

Further, in each ridge of the reinforcement panel 202, the inner portion may be formed to have a smaller inclination value than the side lower panel 203. A section toward the inside of the housing is formed to have an inclination of about 1.5 degrees, and the side lower panel 203 is formed to have an inclination of about 2 degrees, whereby, at the time of lateral collision, the side lower panel 203 is deformed upward at the inner side thereof and downward at the outer side thereof, and thus the overall side structure thereof stably remains as horizontal as possible.

The troughs of the reinforcement panel 202 may be formed to have a larger inclination value than the side lower panel 203. Referring to the cross section taken along B-B′ in FIG. 3, it may be determined that the troughs of the reinforcement panel 202 are formed to have an inclination of about 3.5 degrees, and the side lower panel 203 is formed to have an inclination of about 2 degrees.

Further, in the vehicle battery case according to an embodiment of the present disclosure, the end of the side upper panel 201 may be bent upward, the ends of the side lower panel 203 and the reinforcement panel 202 may be bent downward, and the bent ends may be coupled to each other while being in surface contact with each other or the side surface part of the housing. The end of the side upper panel 201 may be bent downward, the ends of the side lower panel 203 and the reinforcement panel 202 may be bent upward, and the bent ends may be coupled to each other while being in surface contact with each other.

That is, the side upper panel 201, the reinforcement panel 202, and the side lower panel 203 have predetermined inclinations in the inner impact absorption space, and thus, at the time of lateral collision, the overall shapes thereof are uniformly deformed while remaining horizontal, thereby properly absorbing the impact. Further, the panels may be welded while being in surface contact with each other through flanges formed at the ends thereof to form a closed section, thereby withstanding a larger load at the time of collision. In the test result, referring to the graph in FIG. 6, it is determined that a load capable of being withstood by the vehicle battery case (dotted line) according to an embodiment of the present disclosure has increased by about two times compared with the conventional vehicle battery case (solid line).

The present disclosure has been illustrated and described in relation to specific embodiments thereof. However, it will be obvious to those skilled in the art that various changes and modifications therein can be made without departing from the technical spirit of the present disclosure, provided by the following claims.

What is claimed is:

1. A vehicle battery case, comprising:
a housing in which a battery is mounted and which has a side surface part formed to cover a side surface of the battery;
a side upper panel which is coupled to the side surface part of the housing and extends in a longitudinal direction along the side surface part of the housing;
a side lower panel which is coupled to the side surface part of the housing while being spaced downward apart from the side upper panel and extends in the longitudinal direction along the side surface part of the housing, an end of the side lower panel being coupled to an end of the side upper panel so as to form an impact absorption space between the side lower panel and the side upper panel; and
a reinforcement panel which is inserted into the impact absorption space and extends in the longitudinal direction along the side surface part of the housing,
wherein the side lower panel and the reinforcement panel are disposed to have increasing inclinations while extending from the side surface part of the housing in a width direction.

2. The vehicle battery case of claim 1, wherein the reinforcement panel is disposed closer to the side lower panel than to the side upper panel, and when an impact occurs, the reinforcement panel is deformed and brought into contact with the side lower panel.

3. The vehicle battery case of claim 1, wherein the side surface part of the housing comprises multiple side wall panels stacked in the lateral direction, and each of the side upper panel, the side lower panel, and the reinforcement panel has an end coupled to an outermost side wall panel.

4. The vehicle battery case of claim 3, wherein the multiple side wall panels are shaped to extend along a side surface of the housing, and are coupled to each other to form a closed section.

5. The vehicle battery case of claim 1, wherein the side upper panel has multiple protrusions arranged in a longitudinal direction, and each of the protrusions has an end supported by the reinforcement panel.

6. The vehicle battery case of claim 5, wherein the protrusions comprise pipe members formed in a cylindrical shape, the side upper panel has multiple through-holes which are formed in the longitudinal direction and into which the pipe members are inserted, respectively, and the inserted pipe members have bottoms supported by a top surface of the reinforcement panel.

7. The vehicle battery case of claim 1, wherein the reinforcement panel is shaped to be continuously bent in a longitudinal direction, and comprises ridges protruding upward and troughs protruding downward.

8. The vehicle battery case of claim 7, wherein the ridges and troughs of the reinforcement panel have increasing inclinations while extending from the side surface part of the housing in a width direction, and the ridges and the troughs have different inclinations.

9. The vehicle battery case of claim 8, wherein the side upper panel has multiple through-holes formed in a longitudinal direction, the pipe members are inserted into the respective through-holes, and the inserted pipe members have bottoms supported by the ridges of the reinforcement panel.

10. The vehicle battery case of claim 9, wherein each of the ridges of the reinforcement panel comprises: an inner portion extending from the side surface part of the housing in a width direction; and an outer portion extending from the inner portion in the width direction, and each of the pipe members has a bottom supported by the outer portion.

11. The vehicle battery case of claim 10, wherein in each ridge of the reinforcement panel, the inner portion is formed to have a larger inclination value than the outer portion.

12. The vehicle battery case of claim 10, wherein in each ridge of the reinforcement panel, the inner portion is formed to have a smaller inclination value than the side lower panel.

13. The vehicle battery case of claim 8, wherein the troughs of the reinforcement panel are formed to have a larger inclination value than the side lower panel.

14. The vehicle battery case of claim 1, wherein the side upper panel has an end bent upward, the side lower panel and the reinforcement panel have ends bent downward, and the bent ends are coupled to each other while being in surface contact with each other or with the side surface part of the housing.

15. The vehicle battery case of claim 1, wherein the side upper panel has an end bent downward, the side lower panel and the reinforcement panel have ends bent upward, and the bent ends are coupled to each other while being in surface contact with each other.
